(19) United States
(12) Patent Application Publication
(10) Pub. No.: US 2016/0082481 A1
(43) Pub. Date: Mar. 24, 2016

(54) Apparatus and Method for Segregating Contaminants from a Stream of Bulk Material

(71) Applicant: LINDAUER DORNIER GESELLSCHAFT MIT BESCHRÄNKTER HAFTUNG, Lindau (DE)

(72) Inventors: Gerhard GROTE, Lindau (DE); Thomas BUBE, Lindau (DE)

(21) Appl. No.: 14/785,089

(22) PCT Filed: May 5, 2014
(86) PCT No.: PCT/EP2014/059054

§ 371 Date: Oct. 16, 2015

(30) Foreign Application Priority Data
May 8, 2013 (DE) 10 2013 104 740.8

(51) Int. Cl. B07C 5/36

(52) U.S. Cl. CPC B07C 5/36

(57) ABSTRACT

The invention relates to an apparatus for segregating contaminants (1) from a bulk material stream, wherein the apparatus has at least one inlet opening (3) for the bulk material (4), which can be connected with a bulk material feed (2), a segregating unit (5) arranged after the inlet opening (3) in a transport direction (F) of the bulk material stream, as well as at least one outlet (6) for the bulk material (4) freed of contaminants (1) with the aid of the segregating unit (5), arranged after the segregating unit (5) in the mentioned transport direction (F). According to the invention it is proposed that the segregating unit (5) has at least two transport channels (7) that are connected in parallel and branch off from the inlet opening (3), wherein the transport channels (7) respectively are passable by a bulk material partial stream that branches off from the bulk material stream flowing in via the inlet opening (3), and wherein to each one of the transport channels (7) there is allocated at least one detector (8) for the detection of contaminants (1) as well as one separating device (9), with the aid of which the bulk material partial stream passing through the respective transport channel (7) can be redirected into a disposal channel system (10). Furthermore a method for segregating contaminants (1) out of a bulk material stream with the aid of a segregating unit (5) is described, which is characterized in that the bulk material stream is divided into at least two bulk material partial streams before or within the segregating unit (5), wherein each bulk material partial stream is monitored individually with the aid of a separate detector (8) of the detector arrangement (18) with respect to the presence of contaminants (1), and wherein exclusively the bulk material partial stream comprising a contaminant (1) is redirected into a disposal channel system (10).

The present invention relates to an apparatus for segregating contaminants, especially metal, out of a bulk material stream, wherein the apparatus has at least one inlet opening for the bulk material, which inlet opening can be connected with a bulk material feed, a segregating unit that is arranged after or downstream from the inlet opening in a conveying or transport direction of the bulk material stream, and also an outlet for the bulk material that has been freed of contaminants with the aid of the segregating unit, which outlet is arranged after or downstream from the segregating unit in the mentioned transport direction. Moreover, a method for segregating contaminants, especially metal, out of a bulk material stream with the aid of a segregating unit is proposed, wherein the bulk material stream is directed from a bulk material feed via an inlet opening into the segregating unit, and wherein the bulk material stream is monitored within the segregating unit with respect to the presence of contaminants with the aid of a detector arrangement.

In the prior art, numerous applications are known in which a bulk material (for example in the form of a plastic granulate) must be freed of contaminants, before the bulk material can be supplied to its further utilization. Corresponding contaminants in that regard are not only present in natural products, but rather ever more so also in artificially produced or manmade products. Thus, for example in the production of plastic granulates, frequently also recycled plastics are reutilized, which, for example due to insufficient preceding cleaning processes, can comprise metal splinters. If corresponding contaminated plastic granulates are further processed in a corresponding machine, for example an extruder for producing films, then the danger exists that it may lead to a damaging of the machine or at least an interruption of the production process.

In order to counter or prevent this danger, various different solutions are already known in the prior art, to remove corresponding contaminants out of the bulk material stream before the actual processing of the bulk material (e.g. its melting).

For example, a corresponding solution is described in the DE 44 17 226 C1, which describes a metal separator for installation in a conveying device for non-metallic materials in the form of powders, granulates or fluids, wherein a metal detector is arranged before or upstream from a segregating device in the transport direction, and is connected with an evaluating and control unit. The segregating device essentially consists of a suction nozzle that is guided through the casing or jacket surface of the transport device, wherein after the detection of a metal piece by means of the metal detector, via the evaluating and control unit the suction nozzle has applied thereto a pressure that lies below the pressure value prevailing in the transport device.

Alternatively, the EP 0 202 356 A1 describes a transport device for granular transportable material, onto the transport line of which an induction coil is connected, which is connected with a control device for a fall-out flap, through which the metal particles to be segregated can be segregated out of the transportable material via a fall-out opening. In this regard, the fall-out flap and the fall-out opening lie within a segregating container through which the transport line runs through. Within the segregating container, the transport line further comprises an in-flow opening through which the air that gets into the container during the segregating of the metal particles can flow back into the transport line. Because the segregating container is connected directly to the transport line, a bypass line can be omitted.

It is true that with the previously known solutions generally a reliable segregation of especially metal particles out of a bulk material stream is possible. However, simultaneously it always gives rise to an interruption of the bulk material flow, if even only a short one, during the segregation process. This in turn results in an influencing or even an interruption of the subsequent production process. If the machine processing the granulate is an extruder, then a stoppage of the material flow can have as a result a complete stoppage of the extruder or a breaking of the film produced with the aid of the extruder.

It is therefore an object of the present invention to propose an apparatus or respectively a method, with the aid of which contaminants can be segregated out of a bulk material stream, without leading to a breakage or interruption of the bulk material stream.

The object is achieved by an apparatus or respectively a method with the features of the independent patent claims.

The apparatus according to the invention is characterized in that the segregating unit has at least two transport channels that are connected in parallel and that branch off from the inlet opening, wherein the transport channels are each respectively passable by a bulk material partial stream. In other words, the bulk material that flows in via the inlet opening, which may for example be a plastic granulate for subsequent processing in an extruder arranged downstream from the apparatus, is divided into several bulk material partial streams before passing the segregating unit.

In order to be able to monitor the individual bulk material partial streams with respect to the presence of contaminants, furthermore at least one detector for detecting corresponding contaminants is allocated to each one of the transport channels. Preferably the detector is a metal detector, with the aid of which the passing of a metal particle can be recognized.

Finally, a separating unit is allocated to each transport channel, with the aid of which segregating unit the bulk material partial stream passing through the respective transport channel can be redirected into a disposal channel system. Thus, the separating unit serves not for the exclusive removal of the contaminant. Rather it is provided that each bulk material partial stream passes through the apparatus from the inlet opening up to the corresponding outlet as long as the respective detectors provide no signal that allows a conclusion of the presence of a contaminant that is detectable by the detector to be drawn. On the other hand, if one of the detectors indicates the passing of a contaminant, for example a metal particle, then exclusively the bulk material partial stream that passes through the transport channel comprising the corresponding detector is briefly temporarily redirected into the disposal channel system and for example disposed of. The time duration of the redirection is dependent on the transport speed of the bulk material stream and is to be dimensioned or determined so that the detected contaminant together with the bulk material surrounding the contaminant is redirected and is thereby removed from the bulk material stream. After the contaminant has left the segregating unit via the disposal channel system, the redirection is again terminated so that the corresponding bulk material partial stream again leaves the apparatus via the outlet and can be delivered to the further production process.

In contrast to the prior art, thus upon detection of a contaminant only a portion of the bulk material stream is redirected, while the remaining bulk material streams (which are free of contaminants) pass through the apparatus without redirection and can exit the apparatus via the outlet. Thus, the bulk material stream in total never completely breaks, i.e. is never completely interrupted, so that a production stoppage of the subsequent production unit (for example an extruder) can be excluded.

While the invention can already be realized with two parallel-connected transport channels, it has been found to be beneficial to provide more than two transport channels with the corresponding allocated segregating units and detectors. If, for example, three transport channels are utilized, then the mass flow of the bulk material stream passing through the apparatus without redirection is reduced by only one third. With utilization of four transport channels, this value would diminish to one fourth, etc.

In this regard it is generally pointed out that the disposal channel system in the scope of the invention does not necessarily involve an extended pipe system. Rather, the disposal channel system can just as well be formed by outwardly open outlet stubs (pipe stubs) or openings, through which the redirected bulk material partial stream or streams can be ejected into an open container.

In this regard it is advantageous if the separating device respectively comprises a separating element. The separating element can, for example, be embodied as a pivotable switch or shunt element that is movable, with the aid of a drive, between a passing position in which the associated transport channel is passable by one of the bulk material partial streams, and a separating position in which the corresponding bulk material partial stream is redirected into the disposal channel system. In other words, the separating element is thus movable between two positions, whereby the bulk material partial stream that passes through the associated transport channel, in a first position exits the apparatus through the outlet without redirection, and in a second position is redirected into the disposal channel system. In this manner, a reliable redirection of the respective bulk material partial stream is possible, as soon as a contaminant is detected in the area of the detector. The drive in turn can be connected with a control and/or regulating unit, which moves the drive back and forth between the mentioned positions dependent on the signals provided by the respective detector.

It is also advantageous if a divider for dividing the bulk material stream into the individual transport channels is arranged before the transport channels in the mentioned transport direction. Even when an automatic dividing of the bulk material stream passing through the inlet opening can be achieved through a corresponding geometry or arrangement of the transport channels, it is advantageous if a divider is provided for this purpose, which divider ensures a particularly uniform dividing of the bulk material stream. The divider is preferably positioned between the inlet opening and the subsequent transport channels, whereby the inlet opening in turn is connectable or connected with a corresponding bulk material feed. The bulk material feed can, for example, be embodied as a bulk material supply container, which is arranged above the apparatus according to the invention, and which ensures a constant bulk material mass flow or volume flow, for example via a mass flow regulating dosing unit.

Moreover it is advantageous if the divider encompasses several flow guide elements, with the aid of which respectively one bulk material partial stream can be branched off from the bulk material stream flowing in via the inlet opening, and is deflectable into one of the transport channels. In this regard, the divider can, for example, have an inlet stub forming the inlet opening of the apparatus as well as a plurality of outlet openings or outlet stubs, which open into the corresponding transport channels (the number of the outlet openings or stubs in this regard preferably corresponds to the number of the transport channels). Within the divider, in turn there are corresponding flow guide elements, which effectuate a dividing of the bulk material stream flowing in through the inlet opening. The flow guide elements can finally be present, for example, in the form of metal guide plates, which respectively can be tilted obliquely sloping in the direction of the inlet opening within the divider. Similarly it is conceivable to equip the divider with several flow guide elements in the form of flow obstacles. For example, the flow guide elements can be formed by several, e.g. bolt-shaped, installed elements, which preferably extend perpendicularly to the transport direction (for example between two walls of the divider), and onto which the bulk material impinges while passing through the divider, and thereby becomes correspondingly redirected.

In this regard it is advantageous if at least one flow guide element has one or more movably supported guide surface(s). The guide surfaces can, for example with the aid of a drive or manually, be movable, for example in the mentioned transport direction. Similarly also conceivable is the arrangement of one or more guide surfaces of which the angle is changeable so that as a result the proportion or ratio of the mass flows of the individual bulk material partial streams and/or the flow direction of the bulk material stream are at least temporarily changeable. Through this it can finally be ensured that the bulk material mass flow can be divided as uniformly as possible to the individual transport channels.

It is also advantageous if the flow guide element(s) comprising the guide surface(s) is/are arranged before or upstream from the remaining flow guide elements in the mentioned transport direction (F). In this manner, the bulk material stream can be pre-separated to a certain extent, before it impinges on the remaining flow guide elements. If it is determined through corresponding measurements or observations, that the bulk material stream is divided non-uniformly among the individual transport channels, then the proportion or ratio of the respective mass flows can be adapted with the aid of the guide surfaces, before the bulk material stream impinges on the remaining flow guide elements.

It further brings about advantages if the quotient of the sum of the flow cross-sectional areas of the transport channels and the flow cross-sectional area of the inlet opening comprises a value that lies between 2.0 and 0.2, preferably between 1.6 and 0.4, and especially preferably between 1.2 and 0.6. If the value lies above 1, then it is ensured that upon a blocking of one transport channel, a portion of the bulk material partial stream normally flowing via this transport channel can be carried away via one of the remaining transport channels. A value of less than 1, on the other hand, is then advantageous when the mass flow of the bulk material supplied via the inlet opening is smaller than the maximum mass flow that is possible due to the flow diameter of the inlet opening. If now one transport channel would be blocked, then it is also ensured in this case, that the bulk material stream can pass through the apparatus via the remaining transport channels, wherein the transport channels in this case can be embodied smaller than in the first case.

It brings about special advantages if the flow cross-sectional areas of the individual transport channels are equal or deviate from one another by not more than 20%, preferably by not more than 10%. In this case, a uniform distribution of the bulk material stream results, so that the transport channels, the detectors, and the segregating unit can also be embodied similarly or similarly dimensioned.

Likewise it brings about advantages if the transport channels respectively have one outlet opening, whereby the outlet openings together in common form the outlet of the apparatus and essentially lie on one common line. In this case, the apparatus can consist of identical units (consisting of transport channel, segregating unit and subsequent outlet opening), which in turn can be positioned in a parallel connection, for example next to one another in a row. The outlet opening can be a part of an outlet stub of the respective unit, which on the one hand transitions into the segregating unit and on the other hand comprises the mentioned outlet opening. In this regard, the outlet openings can lie in a row next to one another, so that the bulk material partial streams exiting the individual units can again be joined or combined after passing through the apparatus according to the invention.

Additionally it brings about advantages if the outlet openings are respectively embodied slit-shaped and transition into the respective transport channel with a funnel shape opposite the mentioned transport direction. The outlet openings can, for example, be present in the form of outlet stubs that respectively are positioned after (as seen in the transport direction) the segregating device of the respective transport channel or are connected therewith. If the transport channels comprise a round cross-section in the connection to the outlet stubs, then it would be conceivable that the cross-section of the outlet stubs transitions from a round shape into a slit-shaped, for example rectangular, shape. Finally, the outlet openings can be arranged in a row, whereby the longitudinal axes of the outlet openings should lie on a line. This is especially advantageous if the bulk material stream exiting the apparatus according to the invention, before the actual further processing (for example the melting in the extruder), are mixed with a further material, e.g. in the form of plastic flakes, which originate from a preceding process (for example a recycling process of used or waste plastic). If the bulk material stream exits the apparatus in the form of the widest possible stream due to the slit-shaped outlet openings, then after it impinges upon for example a belt scale, it will be present in the form of a wide-drawn and relatively flat bulk material carpet, which thereby can be mixed with the further material especially uniformly (for example in that the further material is poured from above onto the bulk material carpet).

It is advantageous if the outlet openings are arranged directly neighboring or adjacent to one another. Hereby it is ensured that the mentioned bulk material carpet forms a closed or continuous surface, whereby this should comprise a height that is as uniform or unitary as possible.

Likewise it is advantageous if the disposal channel system encompasses a disposal channel that is common to all transport channels as well as individual disposal stubs that open into the respective transport channels. The disposal stubs can, for example, be connected with corresponding connecting elements (e.g. in the form of hose clamps) with the respective transport channels. Likewise it is conceivable that the disposal stubs and/or the disposal channel are embodied curved or bent. The end of the disposal channel oriented away from the respective segregating units can in this manner be positioned at a location that lies outside of the region in which the outlet of the apparatus is located. Preferred is a location that, with respect to the adjacently arranged transport channels, lies laterally next to these, so that the disposal channel system does not collide with a belt scale, which, after installation of the apparatus according to the invention in a machine processing the bulk material, extends under the same.

The method according to the invention for segregating contaminants, especially metal, out of a bulk material stream encompasses the following steps:
introducing a bulk material stream from a bulk material feed (for example a bulk material supply container) via an inlet opening into an apparatus comprising a segregating unit (which can comprise one or more of the previously described features),
dividing the bulk material stream into at least two bulk material partial streams before or within the segregating unit,
individual monitoring of each bulk material partial stream, with respect to the presence of contaminants, with the aid of a detector, of a detector arrangement, allocated to the respective bulk material partial stream, and
redirecting the bulk material partial stream comprising a contaminant into a disposal channel system.

The essence of the method according to the invention thus lies in dividing a bulk material stream (for example a plastic granulate stream) into several (for example two, three of four) bulk material partial streams before the monitoring for contaminants in or before a corresponding segregating unit, and monitoring the individual bulk material partial streams independently of one another with separate detectors. This has the decisive advantage, that upon detection of a contaminant in one of the several bulk material partial streams, only the bulk material partial stream that carries along the contaminant with itself must be redirected into a corresponding disposal channel system. The remaining bulk material partial streams that are not contaminated can in contrast pass through the apparatus without redirection, and be directed to the subsequent production process, for example an extrusion process for producing a plastic film or some other plastic product. The mass flow of the bulk material stream is reduced during the temporary redirection of one or more of the bulk material partial streams. The remaining mass flow, however, is sufficient to adequately supply the bulk material to the production unit connected after the apparatus, and thereby to exclude a production stoppage or production interruption.

In this regard it brings about advantages if the dividing of the bulk material stream into the individual bulk material partial streams is achieved with the aid of guide elements that are arranged before the transport channels in a transport direction of the bulk material stream. With the aid of the guide elements, which can be arranged in the partial section (for example a pipe stub) that adjoins on the inlet opening of the utilized apparatus, the bulk material stream is preferably fanned out so that the most uniform possible distribution of the bulk material stream to the individual parallel-connected transport channels results. After passing through the transport channels, the bulk material partial streams can again be unified or joined and in common together discharged out of the utilized apparatus. Alternatively, however, a separate discharge is conceivable, so that only after impinging on a subsequent transport device, for example a belt scale, the bulk material partial streams are again joined and, if necessary, joined or mixed together with a further material (e.g. a plastic flake stream).

It is especially advantageous if the bulk material stream is divided uniformly among the individual transport channels, or if the mass flows of the bulk material partial streams that pass through the individual transport channels deviate from one another by maximally 20%, preferably maximally 10%. Thereby, similarly embodied structural components (detector, transport channel, segregating unit) can be utilized for the detection of contaminants and the redirection of a bulk material partial stream provided with contaminants, so that the method according to the invention can be carried out in the most economical or cost-advantageous manner and with units that are easy to maintain.

Likewise it is advantageous if the bulk material partial stream comprising a contaminant is redirected into the disposal channel system with the aid of a separating device. The separating device can redirect the bulk material partial stream in the manner of a flow switch or shunt, whereby for this it preferably is connected with a control and/or regulating unit, which moves the separating element dependent on the signals provided by the corresponding detector, between two positions (redirection compared to no redirection of the bulk material partial stream).

It is especially advantageous if the bulk material stream flows through the segregating unit at least partially in a vertical direction. In this case, no additional transport devices are necessary, because the bulk material can flow through the corresponding segregating units due to the influence of gravity. For this, the transport channels preferably extend in the vertical direction or slightly sloped relative to the vertical. The same also applies to the components of the disposal channel system.

Further advantages of the invention are described in the following example embodiments. It is shown by:

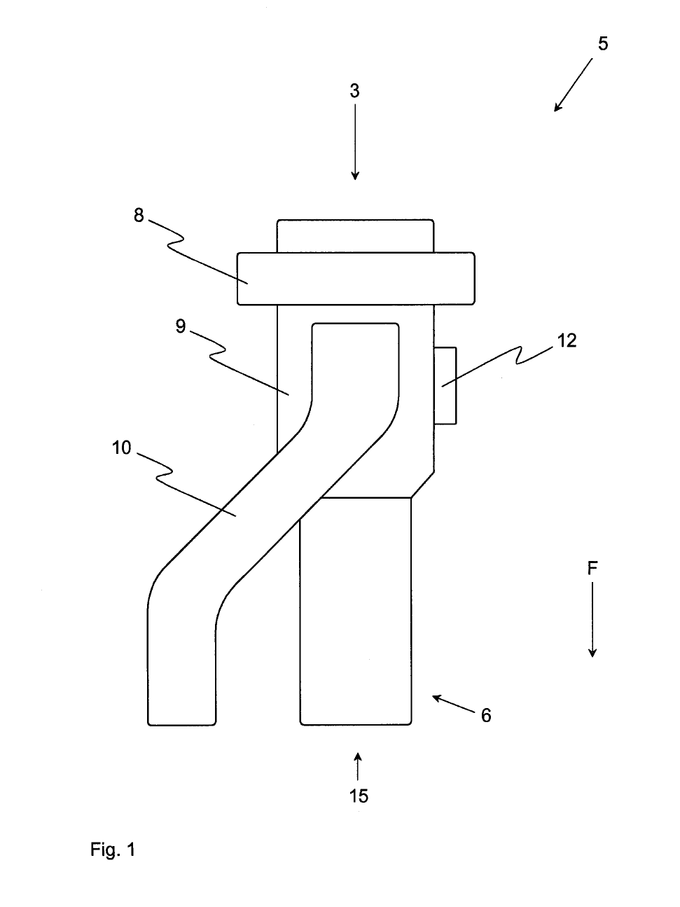

FIG. 1 a front view of a known apparatus for segregating contaminants out of a bulk material stream,

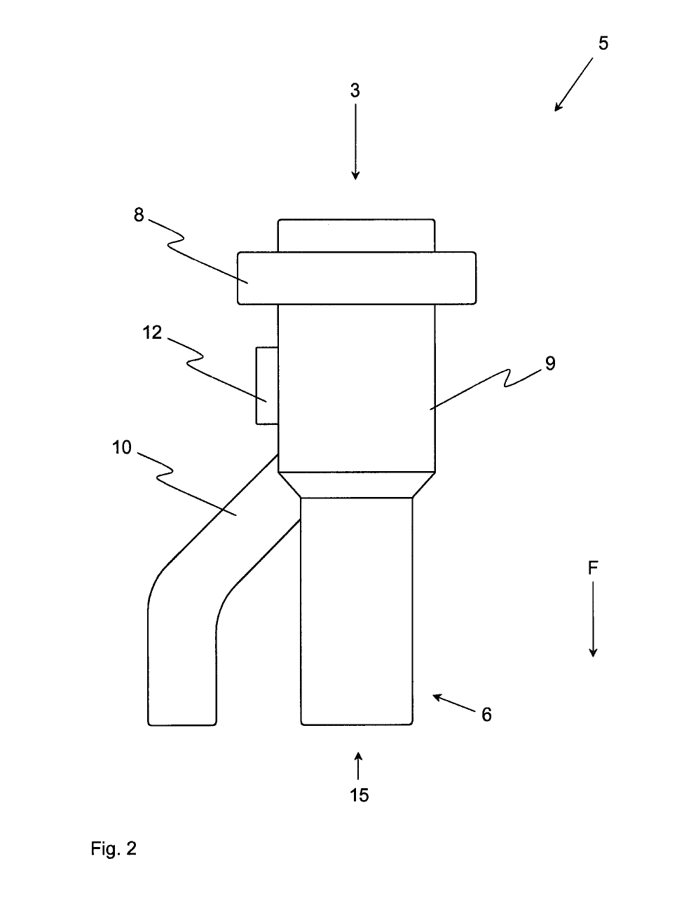

FIG. 2 a rear view of the apparatus shown in FIG. 1,

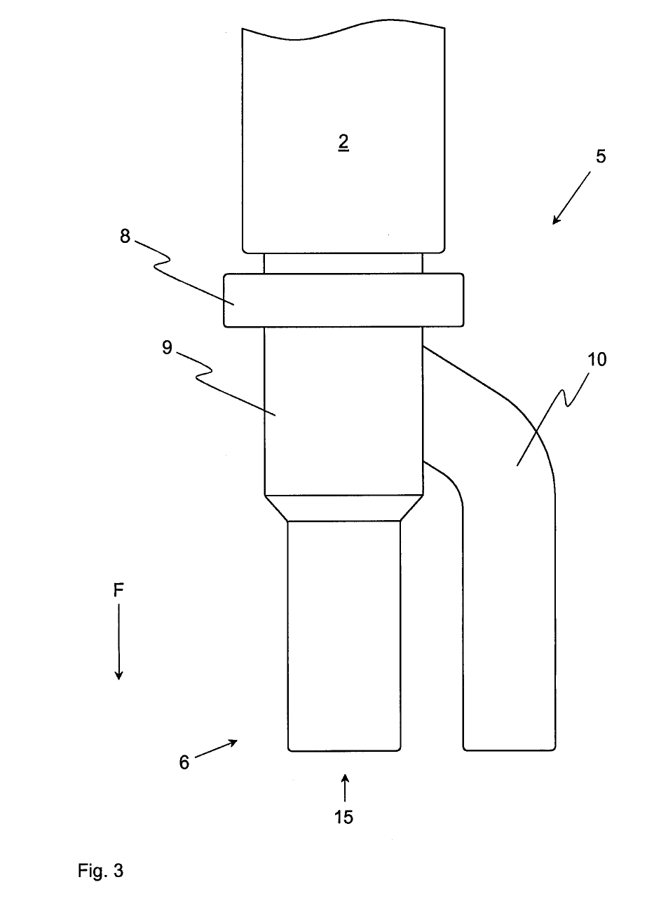

FIG. 3 a side view of the apparatus shown in FIGS. 1 and 2,

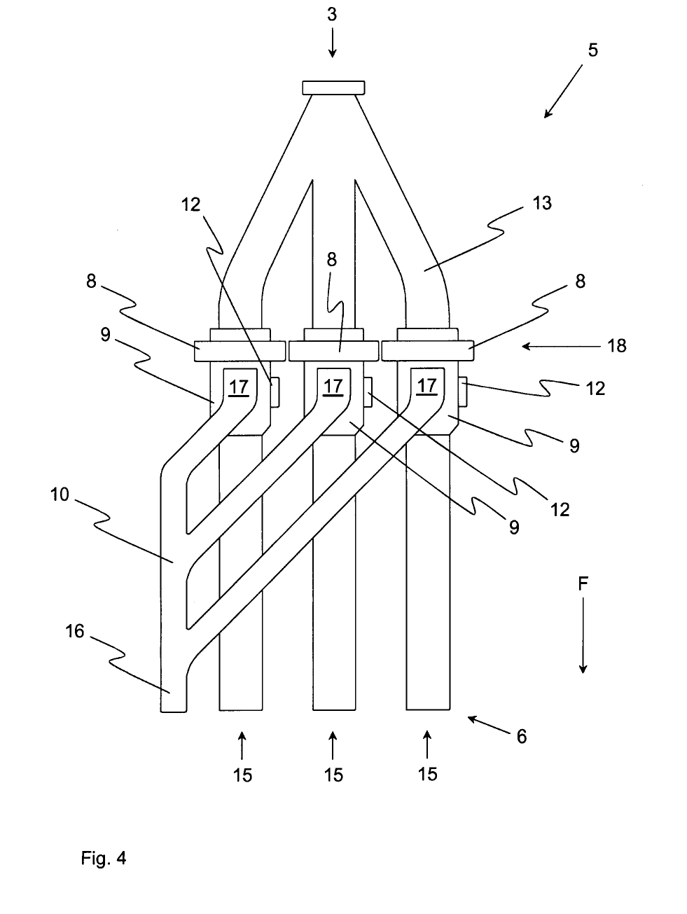

FIG. 4 a front view of an apparatus according to the invention for segregating contaminants out of a bulk material stream,

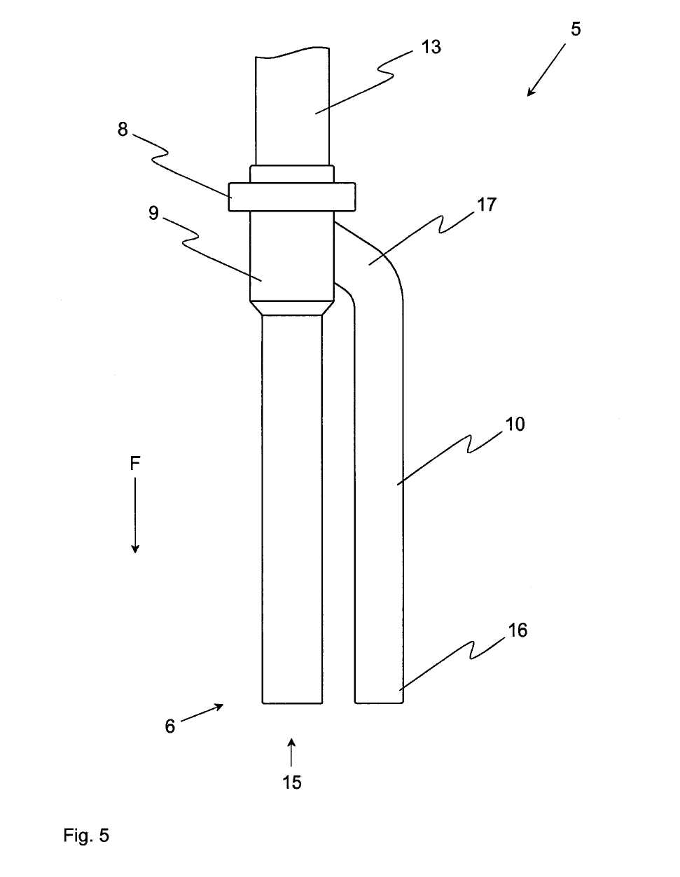

FIG. 5 a partially sectioned side view of the apparatus shown in FIG. 4,

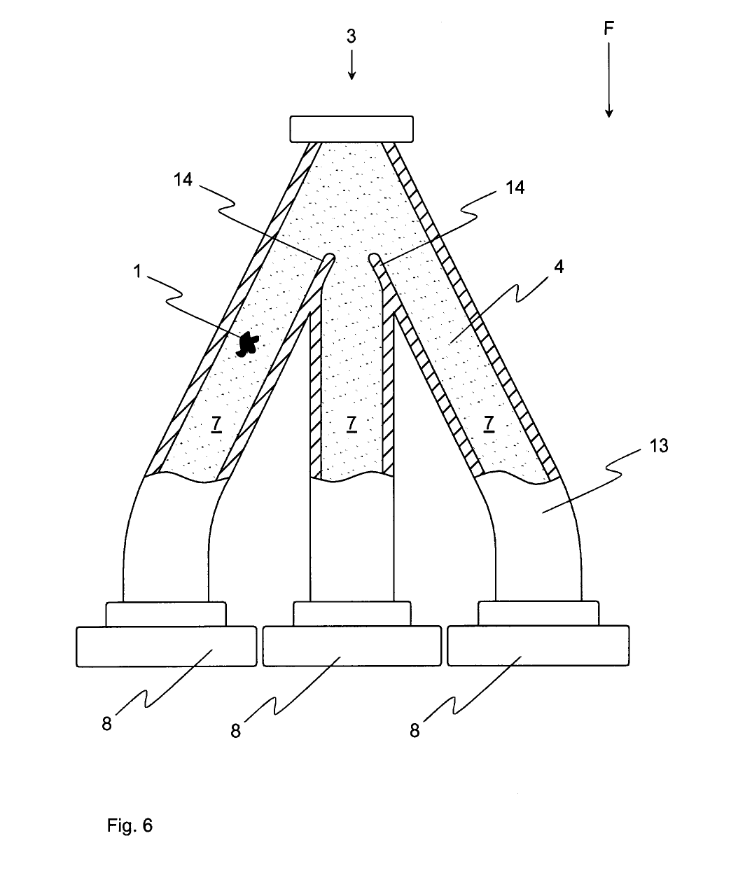

FIG. 6 a partially sectioned cut-away portion of the apparatus shown in FIGS. 4 and 5,

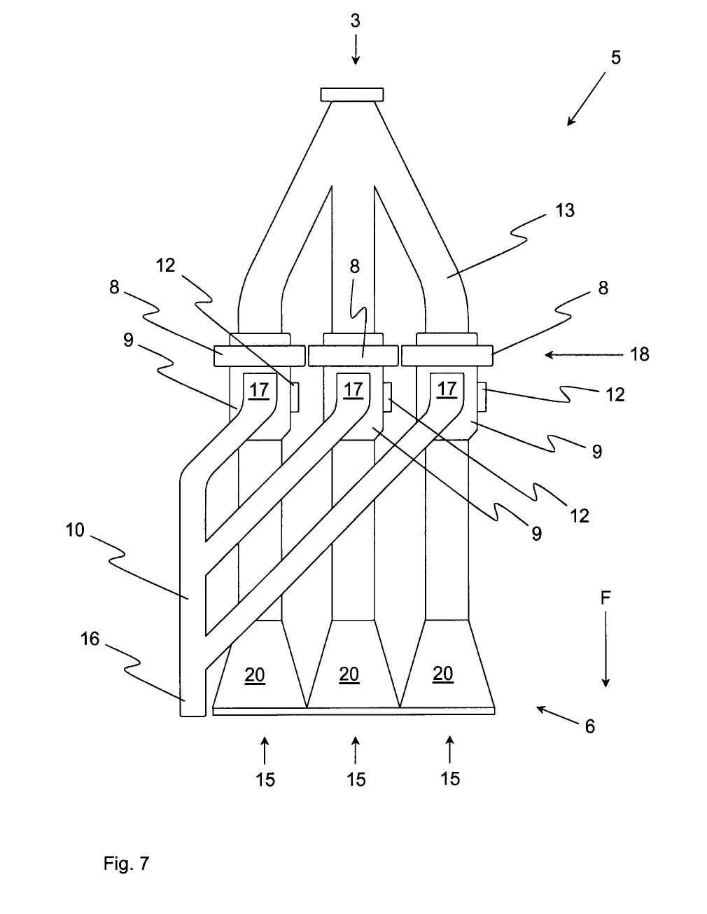

FIG. 7 a front view of a further apparatus according to the invention for segregating contaminants out of a bulk material stream,

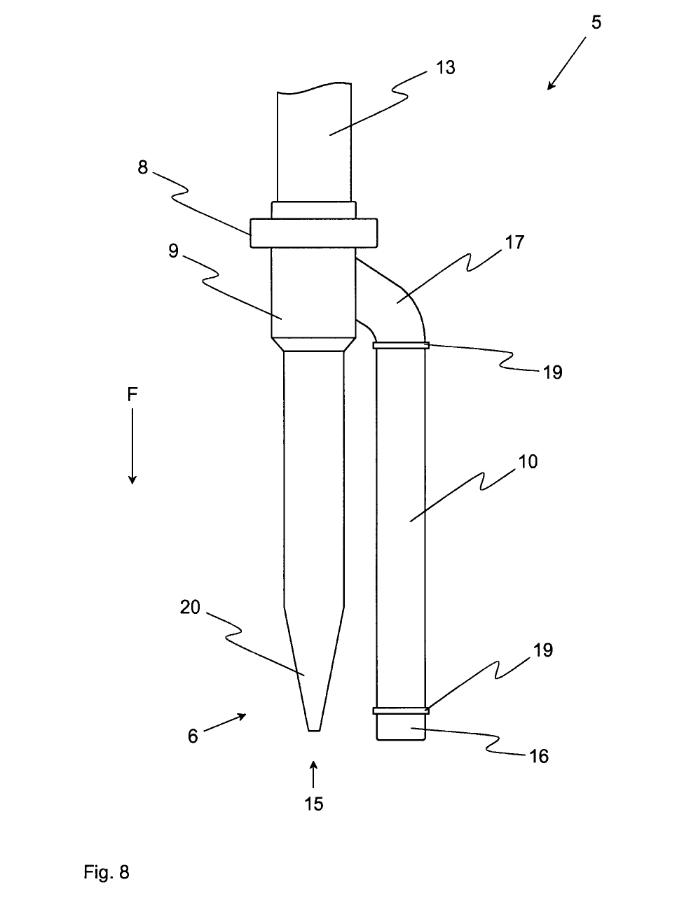

FIG. 8 a partially sectioned side view of the apparatus shown in FIG. 7,

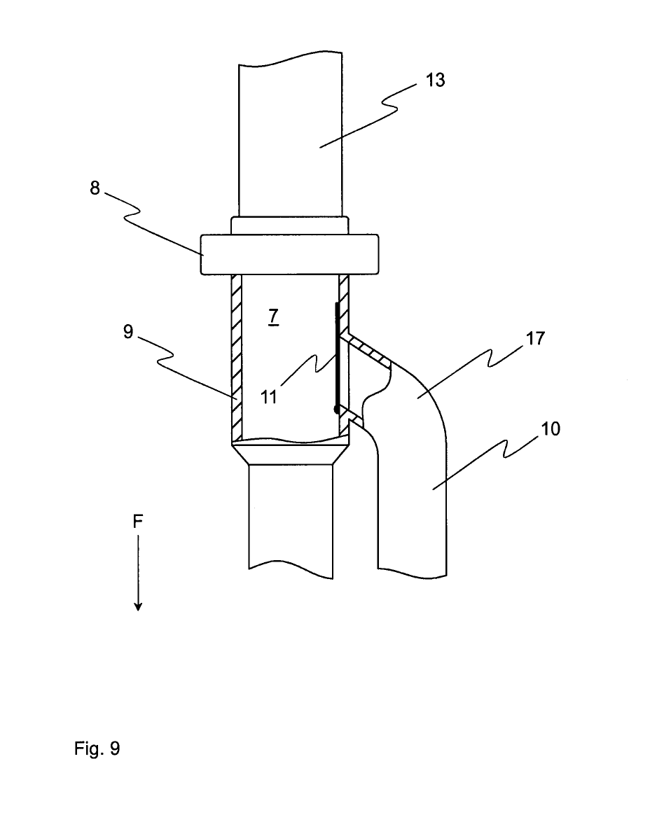

FIG. 9 a partially sectioned cut-away portion of the apparatus shown in FIGS. 7 and 8,

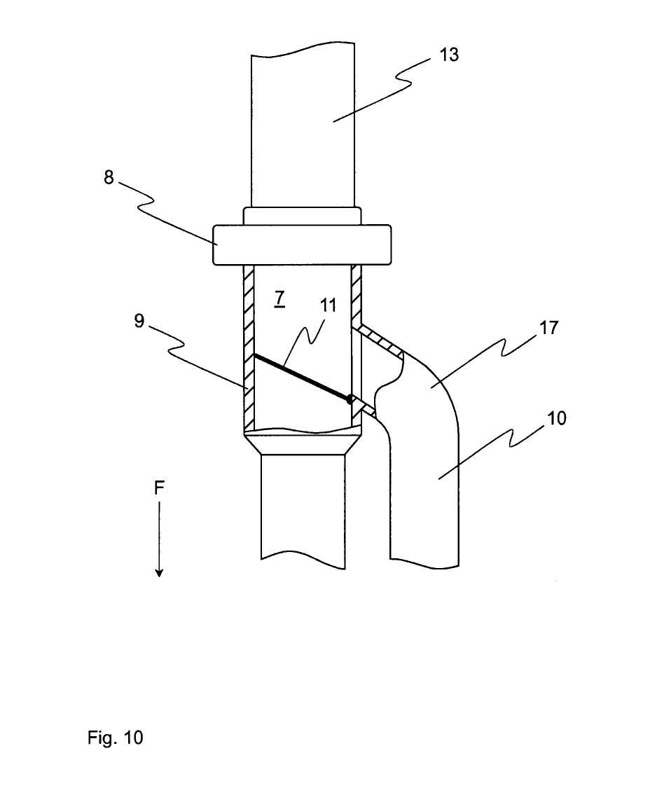

FIG. 10 the cut-away portion shown in FIG. 9 with a changed position of the illustrated separating element, and

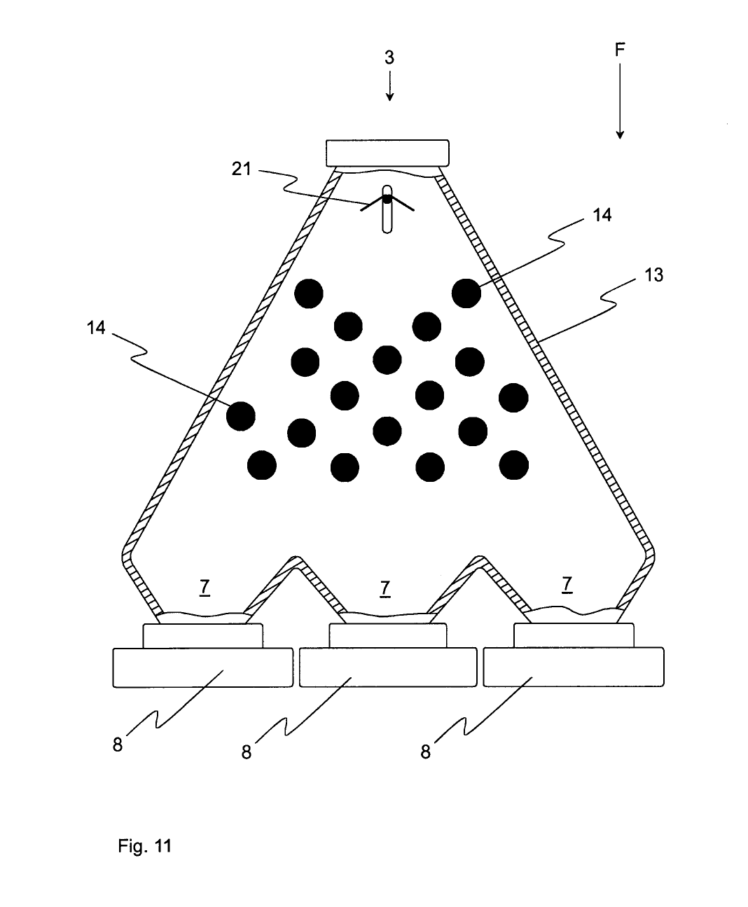

FIG. 11 an alternative embodiment of the cut-away portion shown in FIG. 6.

The FIGS. 1 to 3 show an apparatus that is known with respect to its construction in principle, for segregating contaminants 1 out of a bulk material stream. Such apparatuses are always utilized when a bulk material 4 (e.g. a plastic granulate) that is to be processed in a subsequent production machine (for example an extruder) is to be monitored for contaminants 1 and the contaminants 1 are to be removed from the bulk material stream. Especially in the case of a plastic granulate, metal splinters come into question as contaminants 1, which could lead to a damaging of the machine that processes the plastic granulate and/or an interruption of the corresponding production process.

In order to prevent this, the illustrated apparatus in the illustrated case comprises an inlet opening 3 through which the bulk material stream can be introduced into the apparatus. The bulk material 4 can, for example, originate from a bulk material feed 2 that is exclusively shown in FIG. 3, which can, for example, be embodied as a bulk material container, which releases a constant bulk material mass flow, preferably via a corresponding dosing device.

In the further progression, that is to say in the illustrated transport direction F, the bulk material 4 passes a detector 8 that is designed to detect the contaminants 1 that are to be removed. It is conceivable, for example, to utilize a metal detector, which is known in the prior art, and with the aid of which metal parts or splinters carried along within the bulk material stream can be recognized.

If a signal is produced by the detector 8, which allows the conclusion to be drawn of the presence of a contaminant 1 in the bulk material stream flowing in from above, then (preferably with the aid of a control and/or regulating unit that is not shown) a drive 12 (see FIGS. 1 and 2) is set into operation, which actuates a corresponding actuator element within a segregating unit 5 connected in the transport direction F to the detector 8, in such a manner so that the bulk material stream is redirected into a disposal channel system 10 branching off from the segregating unit 5. The redirection is maintained so long until the detected contaminant 1, inclusive of the bulk material 4 surrounding the contaminant 1, has left the apparatus (the time may, for example, be calculated from the flow speed of the bulk material stream and the dimensions of the segregating unit 5).

Next, the drive 12 is again activated in order to move the mentioned actuator element again into a position in which the bulk material stream passes by the segregating unit 5 without thereby being redirected into the disposal channel system 10. In other words, the bulk material stream passes through the entire apparatus in this case, beginning from the inlet opening 3 via the segregating apparatus and leaves the apparatus finally via the outlet 6 oriented downwardly, in order to then be directed to the further production process.

It is true that with the illustrated solution it is possible to separate detected contaminants 1 out of the bulk material stream. However, because thereby a deflection of the entire bulk material stream always takes place, therefore also the bulk material supply of the subsequent production machine is also interrupted. Even if this interruption usually only lasts for a few seconds, there exists the danger that it leads to a machine stoppage.

In order to prevent or counter this disadvantage, it is now proposed according to the invention that the segregating unit 5 has at least two transport channels 7 that are circuit-connected in parallel and that branch off from the inlet opening 3, as this can be seen for example from the FIGS. 4 and 5 and especially also from the FIG. 6.

In order to divide the bulk material stream into several bulk material partial streams, preferably a divider 13 is connected before the inlet opening 3 in the mentioned transport direction F, which divider 13 effectuates a separating of the bulk material stream, for example with the aid of flow guide elements 14 (see FIG. 6) arranged within the divider 13. After their dividing, the individual bulk material partial streams are directed through the corresponding transport channels 7 (which extend up to an outlet 6) and hereby pass by respectively a detector 8 of a detector arrangement 18 and finally a separating device 9 similarly separately present for each transport channel 7.

If now a contaminant 1 is recognized by one of the detectors 8, then within the corresponding separating device 9 a redirecting of the contaminated bulk material partial stream into a disposal channel system 10 takes place. The redirection takes place for example with the aid of a separating element 11 illustrated in an exemplary manner in the FIGS. 9 and 10, which is movable from a first passing position (FIG. 9) to a second redirecting position (FIG. 10) with the aid of a drive 12.

As a result, only the section of the corresponding bulk material partial stream that contains the contaminant 1 is branched off by redirection out of the actual transport path and can thus be directed away through the disposal channel system 10 and can be disposed of as necessary. While it is conceivable to connect each transport channel 7 with a separate disposal channel system 10, it is advantageous if a common disposal channel system 10 is present for all transport channels 7. As can be seen in this regard for example from FIG. 4, for this the disposal channel system 10 can have a common disposal channel 16 that is connected via individual disposal stubs 17 with the respective separating devices 9. In this regard, the disposal channel 16 and the disposal stubs 17 can be embodied in a one-piece manner. However, it is more advantageous to connect the mentioned elements, preferably releasably, with the aid of corresponding connecting elements 19, which are indicated in FIG. 8. Through this, especially upon the plugging of one of the elements, a maintenance of the disposal channel system 10 is simplified. Furthermore the FIGS. 7 and 8 show a further embodiment of the apparatus according to the invention, which further can similarly comprise a divider 13 in the sense of the previous description. In contrast to the previously described embodiment, this solution is characterized especially by the configuration of the outlet 6. Thus, the individual transport channels 7 respectively encompass an outlet stub 20, which can be embodied in a one-piece manner with the preceding section of the corresponding transport channel 7, or can be connected therewith, for example releasably. Now in contrast to the solution shown in FIG. 4, the outlet stubs 20 respectively have a slit-shaped outlet opening 15, which can be achieved, for example, by a funnel-shaped configuration of the outlet stubs 20. The respective outlet openings 15 are arranged preferably next to one another or flushly aligned with one another (also see FIG. 8), so that the individual bulk material partial streams join with one another upon leaving the apparatus and impinge as a wide bulk material stream onto a catching or receiving apparatus (not shown) lying thereunder. If a conveyor belt or a belt scale is utilized as a catching or receiving apparatus, of which the transport direction extends from the right toward the left (or vice versa) with reference to FIG. 8, then a bulk material carpet, preferably with a homogenous height profile, will be formed on the catching or receiving apparatus. Such a depositing of the bulk material 4 finally ensures that the bulk material 4 can be mixed especially uniformly with one or more additive materials (for example in the form of plastic flakes) before the actual further processing. For this, the additive material must simply be applied uniformly onto the moving bulk material carpet, wherein one or more of the apparatuses according to the invention can be utilized also for the dosing of the additional material.

Finally, a further, partially sectioned, embodiment of the described divider 13 is illustrated in FIG. 11. The divider 13 is characterized in that one of the flow guide elements 14 comprises two, preferably laterally protruding, guide surfaces 21, with the aid of which the bulk material can be divided to a certain extent pre-separated, that is to say into two bulk material partial streams. Finally the two bulk material partial streams impinge in the transport direction onto a plurality of further flow guide elements 14 which finally ensure that the bulk material is divided as uniformly as possible to the individual transport channels 7.

While the guide surfaces 21 are preferably supported movably in the transport direction, in order to be able to influence the flow direction of the pre-separated bulk material partial streams, it is advantageous if the remaining flow guide elements 14 are arranged rigidly or fixedly, whereby it is applicable to embody the mentioned flow guide elements 14 as bolts, which should extend between the walls of the divider 13 that are arranged parallel to the drawing plane in FIG. 11.

Of course, variants of the divider 13 are also conceivable, in which either only the flow guide element 14 comprising the guide surfaces 21 or only the rigidly or fixedly arranged flow guide elements 14 are present.

The present invention is not limited to the example embodiment that has been illustrated and described. Modifications in the scope of the patent claims are likewise possible, just like a combination of the features, even if they are shown and described in different example embodiments.

### REFERENCE NUMBER LIST

1 contaminant
2 bulk material feed
3 inlet opening
4 bulk material
5 segregating unit
6 outlet
7 transport channels
8 detector
9 separating device
10 disposal channel system
11 separating element
12 drive
13 divider
14 flow guide element
15 outlet opening
16 disposal channel
17 disposal stub
18 detector arrangement
19 connecting element
20 outlet stub
21 guide surface
F transport direction

1. An apparatus for segregating contaminants out of a bulk material stream comprising
at least one inlet opening (3), which is connectable with a bulk material feed (2) that feeds a stream of bulk material (4),
a segregating unit (5) arranged after the inlet opening (3) in a transport direction (F) of the bulk material stream, and
at least one outlet (6), which is arranged after the segregating unit (5) in said transport direction (F), for the bulk material (4) which is freed of contaminants (1) with the aid of the segregating unit (5),
wherein the segregating unit (5) has at least two transport channels (7) that are connected in parallel and branch off from the inlet opening (3),
wherein the transport channels (7) are each passable respectively by a bulk material partial stream that branches off from the bulk material stream that flows in via the inlet opening (3), and
wherein the segregating unit further has at least one detector (8) configured and arranged for detection of contaminants (1) as well as one separating device (9) respectively allocated to each one of the transport channels (7), with the aid of which the bulk material partial stream passing the respective transport channel (7) can be redirected into a disposal channel system (10).

2. The apparatus according to claim 1, characterized in that the separating device (9) comprises respectively a separating element (11), which is movable with the aid of a drive (12) between a passing position, in which the associated transport channel (7) is passable by one of the bulk material partial streams, and a separating position, in which the corresponding bulk material partial stream is redirected into the disposal channel system (10).

3. The apparatus according to claim 1, further comprising a divider (13) for dividing the bulk material stream into the individual transport channels (7), which divider is arranged before the transport channels (7) in said transport direction (F).

4. The apparatus according to claim 3, characterized in that the divider (13) comprises several flow guide elements (14) with the aid of which respectively the bulk material partial stream can be branched off from the bulk material stream (4) flowing in via the inlet opening (3) and can be redirected into one of the transport channels (7).

5. The apparatus according to claim 4, characterized in that at least one of the flow guide elements (14) has at least one movably supported guide surface (21), with the aid of which a ratio of mass flows of individual ones of the bulk material partial streams and/or the flow direction of the bulk material stream is at least temporarily changeable.

6. The apparatus according to claim 5, characterized in that the at least one flow guide element having the at least one guide surface (21) is positioned before other remaining ones of the flow guide elements (14) in said transport direction (F).

7. The apparatus according to claim 1, wherein the transport channels and the inlet opening are configured and dimensioned so that a quotient of a sum of flow cross-sectional areas of the transport channels (7) relative to flow cross-sectional areas of the inlet opening (3) has a value that lies between 2.0 and 0.2.

8. The apparatus according to claim 1, characterized in that flow cross sectional areas of individual ones of the transport channels (7) are equal to one another or deviate from one another by not more than 20%.

9. The apparatus according to claim 1, characterized in that the transport channels (7) each respectively have an outlet opening (15), wherein the outlet openings (15) together form the outlet (6) of the apparatus and essentially lie on a common line.

10. The apparatus according to claim 9, characterized in that the outlet openings (15) are each respectively embodied slit-shaped, and transition with a funnel-shape into the respective transport channel (7) contrary to said transport direction.

11. The apparatus according to claim 9, characterized in that the outlet openings (15) are arranged directly adjacent to one another.

12. The apparatus according to claim 1, characterized in that the disposal channel system (10) comprises one disposal channel (16) in common for all of the transport channels (7), as well as individual disposal stubs (17) that open into respective ones of the transport channels (7).

13. A method of segregating contaminants out of a bulk material stream with the aid of a segregating unit (5), comprising
directing the bulk material stream from a bulk material feed (2) via an inlet opening (3) into the segregating unit (5),
monitoring the bulk material stream within the segregating unit (5) with the aid of a detector arrangement (18) with respect to the presence of contaminants (1),
dividing the bulk material stream into at least two bulk material partial streams before or within the segregating unit (5), wherein said monitoring comprises individually monitoring each bulk material partial stream with the aid of a respective separate detector (8) of the detector arrangement (18) with respect to the presence of contaminants (1), and
redirecting exclusively the bulk material partial stream containing a contaminant into a disposal channel system (10).

14. The method according to claim 13, characterized in that the dividing of the bulk material stream into the individual bulk material partial streams is achieved with the aid of guide elements, which are arranged before transport channels (7) in a transport direction (F) of the bulk material stream.

15. The method according to claim 14, characterized in that the bulk material stream is divided uniformly into the transport channels (7), or the mass flows of the bulk material partial streams respectively passing through the transport channels (7) deviate from one another by maximally 20%.

16. The method according to claim 13, characterized in that the redirecting of the bulk material partial stream containing the contaminant (1) into the disposal channel system (10) is performed with the aid of a separating device (9).

17. The method according to claim 13, characterized in that the bulk material stream flows through the segregating unit (5) at least partially in a vertical direction.

18. The apparatus according to claim 7, wherein said value of said quotient is in a range from 0.4 to 1.6.

19. The apparatus according to claim 7, wherein said value of said quotient is in a range from 0.6 to 1.2.

20. The apparatus according to claim 8, wherein the flow cross sectional areas of the individual ones of the transport channels deviate from one another by not more than 10%.
